(19) United States
(12) Patent Application Publication
(10) Pub. No.: US 2018/0336828 A1
(43) Pub. Date: Nov. 22, 2018

(54) DISPLAY PANEL AND DISPLAY DEVICE

(71) Applicant: Shenzhen China Star Optoelectronics Technology Co., Ltd., Shenzhen, Guangdong (CN)

(72) Inventors: Yuyeh CHEN, Shenzhen, Guangdong (CN); Yinhung CHEN, Shenzhen, Guangdong (CN); Anle HU, Shenzhen, Guangdong (CN)

(21) Appl. No.: 15/327,525

(22) PCT Filed: Dec. 28, 2016
(86) PCT No.: PCT/CN2016/112539

§ 371 Date: Jan. 19, 2017

(30) Foreign Application Priority Data
Dec. 20, 2016 (CN) 201611183587.X

(51) Int. Cl. G09G 3/34

(52) U.S. Cl. CPC G09G 3/34

(57) ABSTRACT

The present disclosure provides a display panel which includes a display panel body and at least two driving circuit boards. The display panel body includes data lines, scan lines, pixel units, and circuit board wirings. Each of the driving circuit boards includes a circuit board body, first bridge wirings, and a second bridge wiring. The second bridge wiring is connected to the circuit board wirings and the circuit board body. The first bridge wirings are connected to the data lines, the scan lines, and the circuit board body.

### BACKGROUND OF THE INVENTION

### Field of Invention

The present disclosure relates to a display driving field, and more particularly to a display panel and a display device.

### Description of Prior Art

Currently, sizes of glass substrates utilized by display panel manufacturers are increasing due to upgrading. Sizes of produced display panel are also increasing, for example, 65 inches, 85 inches, and 110 inches. When a size of a display panel is large, a size of a driving circuit board utilized with the display panel is larger.

However, since a manufacturing process of a printed circuit board is limited, a maximum size of a conventional driving circuit board is only 600 millimeters (mm). Accordingly, when the size of the display panel is large, plural driving circuit boards are required. Please refer to FIG. 1. FIG. 1 is a structural diagram of a conventional display panel. The display panel 10 includes a display panel body 11, a first driving circuit board 12, and a second driving circuit board 13 disposed at one side of the display panel 11. A first connector 121 is disposed on the first driving circuit board 12, and a second connector 131 is disposed on the second driving circuit board 13. The first connector 121 and the second connector 131 are connected together through a flexible flat cable (FFC) or a flexible printed circuit (FPC), so as to transmit signals between the first driving circuit board 12 and the second driving circuit board 13.

Since prices of the first connector 121, the second connector 131, and the flexible flat cable (flexible printed circuit) are expensive, the manufacturing costs of the display panel and the display device are high.

Consequently, there is a need to provide a display panel and a display device to solve the problem in the prior art.

### SUMMARY OF THE INVENTION

An objective of the present disclosure is to provide a display panel and a display device having low manufacturing costs to solve the technical problem that a conventional display panel and a conventional display device have high manufacturing costs.

An embodiment of the present disclosure provides a display panel which includes a display panel body and at least two driving circuit boards;

The display panel body including data lines, scan lines, pixel units formed by intersecting the data lines with the scan lines, and circuit board wirings configured to connect the different circuit boards;

Each of the driving circuit boards including a circuit board body, first bridge wirings, and a second bridge wiring, wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals;

Two terminals of the second bridge wirings are disposed on and bonded to the driving circuit board and the circuit board wirings; the first bridge wirings and the second bridge wiring are signal wirings disposed on a chip on film (COF) substrate.

An embodiment of the present disclosure further provides a display panel which includes a display panel body and at least two driving circuit boards;

The display panel body including data lines, scan lines, pixel units formed by intersecting the data lines with the scan lines, and circuit board wirings configured to connect the different circuit boards;

Each of the driving circuit boards including a circuit board body, first bridge wirings, and a second bridge wiring, wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals.

In the display panel of the present disclosure, the circuit board wirings are formed on the display panel body by performing a lithography process to an array substrate.

In the display panel of the present disclosure, the scan lines are manufactured by a first metal layer, the data lines are manufactured by a second metal layer, and the circuit board wirings are manufactured by the first metal layer and the second metal layer.

In the display panel of the present disclosure, the circuit board wirings disposed in the first metal layer and the circuit board wirings disposed in the second metal layer are parallel.

In the display panel of the present disclosure, a first via is disposed in an insulating layer on the first metal layer, a second via is disposed in an insulating layer on the second metal layer, and the circuit board wirings are connected to the second bridge wiring through a transparent electrode which covers both the first via and the second via.

In the display panel of the present disclosure, two terminals of the second bridge wirings are disposed on and bonded to the driving circuit board and the circuit board wirings.

In the display panel of the present disclosure, the first bridge wirings and the second bridge wiring are signal wirings disposed on a chip on film (COF) substrate.

In the display panel of the present disclosure, the first bridge wirings and the second bridge wiring are formed on the COF substrate by performing a lithography process to the COF substrate.

An embodiment of the present disclosure further provides a display device which includes a display panel and a backlight module, wherein the display panel includes a display panel body and at least two driving circuit boards;

The display panel body includes data lines, scan lines, pixel units formed by intersecting the data lines with the scan lines, and circuit board wirings configured to connect the different circuit boards;

Each of the driving circuit boards including a circuit board body, first bridge wirings, and a second bridge wiring, wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals.

In the display device of the present disclosure, the circuit board wirings are formed on the display panel body by performing a lithography process to an array substrate.

In the display device of the present disclosure, the scan lines are manufactured by a first metal layer, the data lines are manufactured by a second metal layer, and the circuit board wirings are manufactured by the first metal layer and the second metal layer.

In the display device of the present disclosure, the circuit board wirings disposed in the first metal layer and the circuit board wirings disposed in the second metal layer are parallel.

In the display device of the present disclosure, a first via is disposed in an insulating layer on the first metal layer, a second via is disposed in an insulating layer on the second metal layer, and the circuit board wirings are connected to the second bridge wiring through a transparent electrode which covers both the first via and the second via.

In the display device of the present disclosure, two terminals of the second bridge wirings are disposed on and bonded to the driving circuit board and the circuit board wirings.

In the display device of the present disclosure, the first bridge wirings and the second bridge wiring are signal wirings disposed on a chip on film (COF) substrate.

In the display device of the present disclosure, the first bridge wirings and the second bridge wiring are formed on the COF substrate by performing a lithography process to the COF substrate.

Compared with the conventional display panel and the conventional display device, the second bridge wirings and the circuit board wirings are connected to different driving circuit boards in the display panel and the display device in accordance with the present disclosure, so that the manufacturing cost of connecting devices on the driving circuit boards can be reduced. The manufacturing cost of the display panel can be reduced as well, and the technical problem that the manufacturing costs of the display panel and the display device are expensive in the prior art can be solved.

For a better understanding of the aforementioned content of the present disclosure, preferable embodiments are illustrated in accordance with the attached figures for further explanation.

### BRIEF DESCRIPTION OF THE DRAWINGS

FIG. 1 is a structural diagram of a conventional display panel.

FIG. 2A is a structural diagram of a display panel in accordance with a preferred embodiment of the present disclosure.

FIG. 2B is an enlarged diagram of an area B in FIG. 2A.

FIG. 3 is a cross-sectional diagram along A-A′ in FIG. 2A.

FIG. 4 is a structural diagram of circuit board wirings on an array substrate of the display panel in accordance with the preferred embodiment of the present disclosure.

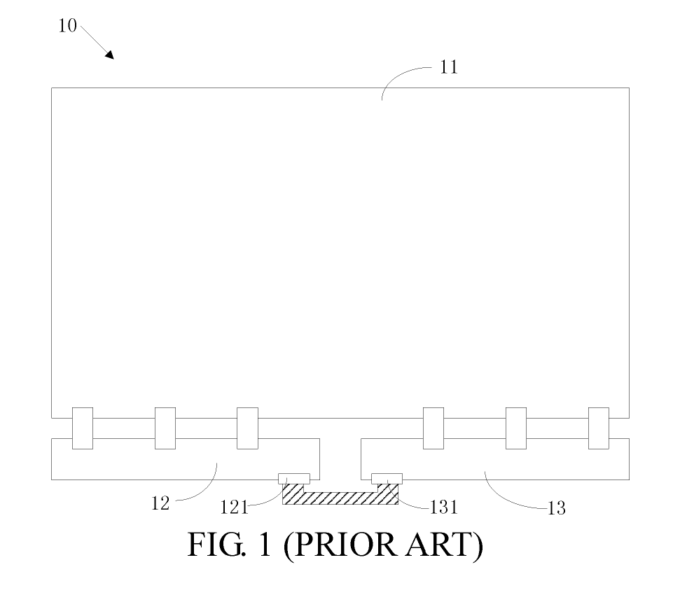

### DETAILED DESCRIPTION OF THE PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side and etc., are only directions by referring to the accompanying drawings, and thus the used directional terms are used to describe and understand the present disclosure, but the present disclosure is not limited thereto.

In the drawings, structure-like elements are labeled with like reference numerals.

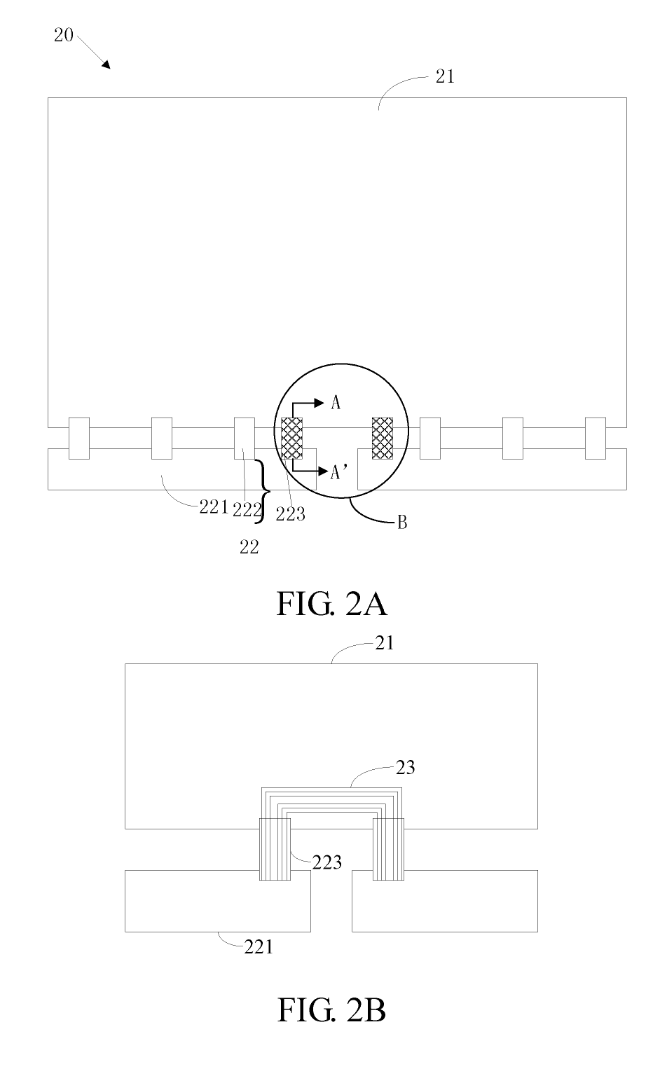

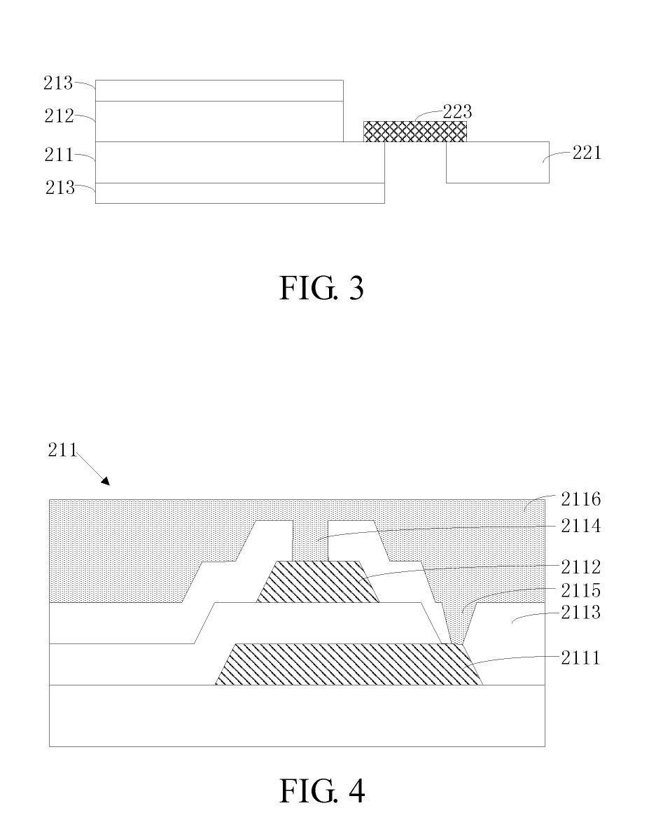

Please refer to FIG. 2 to FIG. 4. FIG. 2A is a structural diagram of a display panel in accordance with a preferred embodiment of the present disclosure. FIG. 2B is an enlarged diagram of an area B in FIG. 2A. FIG. 3 is a cross-sectional diagram along A-A′ in FIG. 2A. FIG. 4 is a structural diagram of circuit board wirings on an array substrate of the display panel in accordance with the preferred embodiment of the present disclosure.

The display panel 20 in accordance with the preferred embodiment includes a display panel body 21 and at least two driving circuit boards 22. The display panel body 21 includes data lines (not shown), scan lines (not shown), pixel units formed by intersecting the data lines with the scan lines, and circuit board wirings configured to connect the different circuit boards 22. Each of the driving circuit boards 22 includes a circuit board body 221, first bridge wirings 222, and a second bridge wiring 223. The circuit board body 221 is configured to support the first bridge wirings 222 and the second bridge wiring 223. That is, one terminal of each of the first bridge wirings 222 and one terminal of the second bridge wiring 223 are fixed on the circuit board body 221. The first bridge wirings 222 are connected to the data lines, the scan lines, and the circuit board body 221 and configured to transmit data signals and scan signals under control of cascade signals. The second bridge wiring 223 is connected to the circuit board wirings 23 and the circuit board body 221 and configured to transmit the cascade signals.

As shown in FIG. 3 and FIG. 4, the circuit board wirings 23 (not shown in FIG. 3) are formed on the display panel body 21 by performing a lithography process to a first metal layer 2111 and a second metal layer 2112 on the array substrate 211. As such, the scan lines and a part of the circuit board wirings 23 can be formed by performing the lithography process to the first metal layer 2111. The data lines and the other part of the circuit board wirings 23 can be formed by performing the lithography process to the second metal layer 2112. Herein, the scan lines and the part of the circuit board wirings 23 are positioned in the first metal layer 2111, but the scan lines and the part of the circuit board wirings 23 are insulated with each other. The data lines and the other part of the circuit board wirings 23 are positioned in the second metal layer 2112, but the data lines and the other part of the circuit board wirings 23 are insulated with each other as well.

When the circuit board wirings 23 on the display panel body 21 in accordance with the preferred embodiment is utilized, the circuit board wirings 23 in the first metal layer 2111 and the circuit board wirings 23 in the second metal layer 2112 are parallel. Specifically, a first via 2115 is disposed in an insulating layer 2113 on the first metal layer 2111, and a second via 2114 is disposed in an insulating layer 2113 on the second metal layer 2112. The circuit board wirings 23 are connected to the second bridge wiring 223 through a transparent electrode 2116 which covers both the first via 2115 and the second via 2114, so that the circuit board wirings 23 in the first metal layer 2111 and the circuit board wirings 23 in the second metal layer are parallel.

The first bridge wirings 222 and the second bridge wiring are signal wirings disposed on a chip on film (COF) substrate. The COF substrate is a thin film substrate excluding a chip. The first bridge wirings 222 and the second bridge wiring 223 can be formed by performing a lithography process to the COF substrate. Two terminals of the second bridge wiring 223 are disposed on and bonded to the driving circuit board 221 and the circuit board wirings 23.

The display panel in accordance with the preferred embodiment includes two driving circuit boards 22. When the display panel in accordance with the preferred embodiment is utilized, the two driving circuit board 22 provides the data signals for the data lines on the display panel body 21 through the first bridge wirings 222.

When one of the driving circuit boards 22 requires transmitting cascade signals to the other one of the driving circuit boards 22, the one of the driving circuit boards 22 is connected to the circuit board wirings 23 on the display panel body 21 through the second bridge wiring 223. Specifically, the second bridge wiring 223 is connected to the circuit board wirings 23 in the first metal layer 2111 and the circuit board wirings 23 in the second metal layer 2112 through the transparent electrode 2116 on the display panel body 21. Specifically, as shown in FIG. 4, the circuit board wirings 23 in the first metal layer 2111 and the circuit board wirings 23 in the second metal layer 2112 transmit the cascade signals of the one of the driving circuit boards 22.

Then, the other one of the driving circuit boards 22 is connected to the circuit board wirings on the display panel 21 through the corresponding second bridge wiring 223, so as to receive the cascade signals of the one of the driving circuit boards 22. As such, transmission of the cascade signals between the one of the driving circuit boards 22 and the other one of the driving circuit boards 22 is completed.

Transmission of the cascade signals is implemented by the second bridge line 223 manufactured on the COF substrate and the circuit board wirings 23 on the display panel body 21, and thus the two driving circuit boards 22 do not need any other connector and connecting line. Accordingly, manufacturing cost of the two driving circuit boards 22 is lower. Furthermore, no connector is disposed on the two driving circuit boards 22, and thus a plugging operation is not required. Lifespan of the two driving circuit boards 22 is further increased.

Since the circuit board wirings 23 in the first metal layer 2111 and the circuit board wirings 23 in the second metal layer 2112 are disposed in parallel, a line impedance of the circuit board wirings 23 can be reduced to ensure that a signal stability of the cascade signals.

As such, a transmission process of the driving circuit boards 22 of the display panel 20 is completed.

In the display panel in accordance with the preferred embodiment, the second bridge wirings and the circuit board wirings are connected to different driving circuit boards, so that the manufacturing cost of connecting devices on the driving circuit boards can be reduced. The manufacturing cost of the display panel can be reduced as well.

The present disclosure further provides a display device. The display device includes a display panel and a backlight module. The display panel includes a display panel body and at least two driving circuit boards. The display panel body includes data lines, scan lines, pixel units formed by intersecting the data lines with the scan lines, and circuit board wirings configured to connect the different circuit boards. Each of the driving circuit boards includes a circuit board body, first bridge wirings, and a second bridge wiring. The second bridge wiring is connected to the circuit board wirings and the circuit board body and configured to transmit cascade signals. The first bridge wirings are connected to the data lines, the scan lines, and the circuit board body and configured to transmit data signals and scan signals under control of the cascade signals.

Preferably, the circuit board wirings are formed on the display panel body by performing a lithography process to an array substrate.

Preferably, the scan lines are manufactured by a first metal layer, and the data lines are manufactured by a second metal layer. The circuit board wirings are manufactured by the first metal layer and the second metal layer.

Preferably, the circuit board wirings disposed in the first metal layer and the circuit board wirings disposed in the second metal layer are parallel.

Preferably, a first via is disposed in an insulating layer on the first metal layer, and a second via is disposed in an insulating layer on the second metal layer. The circuit board wirings are connected to the second bridge wiring through a transparent electrode which covers both the first via and the second via.

Preferably, two terminals of the second bridge wirings are disposed on and bonded to the driving circuit board and the circuit board wirings.

Preferably, the first bridge wirings and the second bridge wiring are signal wirings disposed on a chip on film (COF) substrate.

Preferably, the first bridge wirings and the second bridge wiring are formed on the COF substrate by performing a lithography process to the COF substrate.

A specific operating principle of the display device in accordance with the present disclosure is the same as or similar to corresponding descriptions of the above-mentioned display panel in accordance with the preferred embodiment. An embodiment can be referred to the corresponding descriptions of the above-mentioned display panel in accordance with the preferred embodiment.

In the display panel and the display device in accordance with the present disclosure, the second bridge wirings and the circuit board wirings are connected to different driving circuit boards, so that the manufacturing cost of connecting devices on the driving circuit boards can be reduced. The manufacturing cost of the display panel can be reduced as well, and the technical problem that the manufacturing costs of the display panel and the display device are expensive in the prior art can be solved.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A display panel, comprising a display panel body and at least two driving circuit boards;
the display panel body comprising data lines, scan lines, pixel units formed by intersecting the data lines with the scan lines, and circuit board wirings configured to connect the different circuit boards;
each of the driving circuit boards comprising a circuit board body, first bridge wirings, and a second bridge wiring,
wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals;
wherein two terminals of the second bridge wirings are disposed on and bonded to the driving circuit board and the circuit board wirings; the first bridge wirings and the second bridge wiring are signal wirings disposed on a chip on film (COF) substrate.

2. A display panel, comprising a display panel body and at least two driving circuit boards;
the display panel body comprising data lines, scan lines, pixel units formed by intersecting the data lines with the scan lines, and circuit board wirings configured to connect the different circuit boards;
each of the driving circuit boards comprising a circuit board body, first bridge wirings, and a second bridge wiring,
wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals.

3. The display panel of claim 2, wherein the circuit board wirings are formed on the display panel body by performing a lithography process to an array substrate.

4. The display panel of claim 3, wherein the scan lines are manufactured by a first metal layer, the data lines are manufactured by a second metal layer, and the circuit board wirings are manufactured by the first metal layer and the second metal layer.

5. The display panel of claim 4, wherein the circuit board wirings disposed in the first metal layer and the circuit board wirings disposed in the second metal layer are parallel.

6. The display panel of claim 5, wherein a first via is disposed in an insulating layer on the first metal layer, a second via is disposed in an insulating layer on the second metal layer, and the circuit board wirings are connected to the second bridge wiring through a transparent electrode which covers both the first via and the second via.

7. The display panel of claim 2, wherein two terminals of the second bridge wirings are disposed on and bonded to the driving circuit board and the circuit board wirings.

8. The display panel of claim 2, wherein the first bridge wirings and the second bridge wiring are signal wirings disposed on a chip on film (COF) substrate.

9. The display panel of claim 8, wherein the first bridge wirings and the second bridge wiring are formed on the COF substrate by performing a lithography process to the COF substrate.

10. A display device, comprising a display panel and a backlight module,
wherein the display panel comprises a display panel body and at least two driving circuit boards;
the display panel body comprises data lines, scan lines, pixel units formed by intersecting the data lines with the scan lines, and circuit board wirings configured to connect the different circuit boards;
each of the driving circuit boards comprising a circuit board body, first bridge wirings, and a second bridge wiring,
wherein the second bridge wiring is connected to the circuit board wirings and the circuit board body and configured to transmit cascade signals; the first bridge wirings are connected to the data lines, the scan lines, and the circuit board body and configured to transmit data signals and scan signals under control of the cascade signals.

11. The display device of claim 10, wherein the circuit board wirings are formed on the display panel body by performing a lithography process to an array substrate.

12. The display device of claim 11, wherein the scan lines are manufactured by a first metal layer, the data lines are manufactured by a second metal layer, and the circuit board wirings are manufactured by the first metal layer and the second metal layer.

13. The display device of claim 12, wherein the circuit board wirings disposed in the first metal layer and the circuit board wirings disposed in the second metal layer are parallel.

14. The display device of claim 13, wherein a first via is disposed in an insulating layer on the first metal layer, a second via is disposed in an insulating layer on the second metal layer, and the circuit board wirings are connected to the second bridge wiring through a transparent electrode which covers both the first via and the second via.

15. The display device of claim 10, wherein two terminals of the second bridge wirings are disposed on and bonded to the driving circuit board and the circuit board wirings.

16. The display device of claim 10, wherein the first bridge wirings and the second bridge wiring are signal wirings disposed on a chip on film (COF) substrate.

17. The display device of claim 16, wherein the first bridge wirings and the second bridge wiring are formed on the COF substrate by performing a lithography process to the COF substrate.
